(19) United States
(12) Patent Application Publication
(10) Pub. No.: US 2003/0204582 A1
(43) Pub. Date: Oct. 30, 2003

(54) Wireless personal area network scalable migration of resources

(76) Inventors: Marion H. Shimoda, Aloha, OR (US); Rajesh P. Banginwar, Hillsboro, OR (US); Travis T. Shultz, Hillsboro, OR (US); Thomas M. Cronin, Hillsboro, OR (US); Roger A. Hurwitz, Portland, OR (US); Douglas C. Sommer, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/135,230

(22) Filed: Apr. 29, 2002

(51) Int. Cl. G06F 15/173

(52) U.S. Cl. 709/223

(57) ABSTRACT

A scalable migration of resources between devices in a wireless personal area network is described. According to one embodiment of the invention, a local device using a local resource detects an event on a wireless personal area network. The use of the resource is then migrated to a remote device based on a policy rule associated with the event.

### BACKGROUND

1. Field of the Invention

Embodiments of the invention relate to the field of network computing. More specifically to the scalable migration of resources between devices in a wireless personal area network (WPAN).

2. Background

The emergent versatility of wireless mobile devices has helped them become an increasingly popular accessory in the home and corporate computing environment. In addition to being able to perform their primary functions, mobile devices have additional communication, processing, and storage capabilities that enable them to make their resources available to devices they come into proximity of and to use resources of devices in their proximity.

Typically, to access or share a resource between a device using wireless technology, the user of the device must place the device within the proximity of another device with which it would like to access or share resources. The user of the device would then initiate the service to be used or shared. For example, a personal digital assistant (PDA) has the capability to transfer a specific application and personal information with other compatible devices (e.g., a synchronized desktop computer or another PDA).

In another example, a laptop computer may make a wireless connection to a printer (e.g., via an infrared port) to print a specific document. In each case, the user must manually select the resource to be used and initiate the processing of the available services.

Limitations exist when a device shares resources as the WPAN environment changes. For example, a device ceases to operate when another device with which it is sharing resources moves outside the range of the WPAN. In these situations, the user would be required to re-initialize a connection with another resource on the local or remote device. However, the user might not always know which of the resources on the WPAN is the most optimal or superior resource to use. This is also a limitation if a new resource has connected to the WPAN with superior resource characteristics while a device is sharing or accessing another resource.

In many situations, the user is not aware of a superior resource connecting into range of the WPAN, or which resource is superior on the WPAN. Therefore, the user might not always connect the device with the most optimal or superior resource available.

### BRIEF DESCRIPTION OF THE DRAWINGS

The invention may be understood by referring to the following description and accompanying drawings that are used to illustrate embodiments of the invention. In the drawings:

FIG. 1 illustrates a block diagram of a wireless personal area network according to an embodiment.

FIG. 2 illustrates a block diagram of a scalable migration system according to the embodiment.

FIG. 3 illustrates a processing flow diagram for accessing a remote resource according to one embodiment.

FIG. 4 illustrates a processing flow diagram of the utilization of a local resource on a local device according to one embodiment.

FIG. 5 illustrates an exemplary processing system in which the present invention may be implemented.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

The scalable migration of resources between devices in a wireless personal area network is described. A wireless personal area network (WPAN) scalable migration system enables a device to augment its functionality by scaling the resources it uses as the WPAN environment changes. Specifically, as devices connect and disconnect from a WPAN or change state, a determination is made as to whether a device should use the remote resources of a newly coupled device or whether to permit local resources to be utilized by a remote device, as will be further described below.

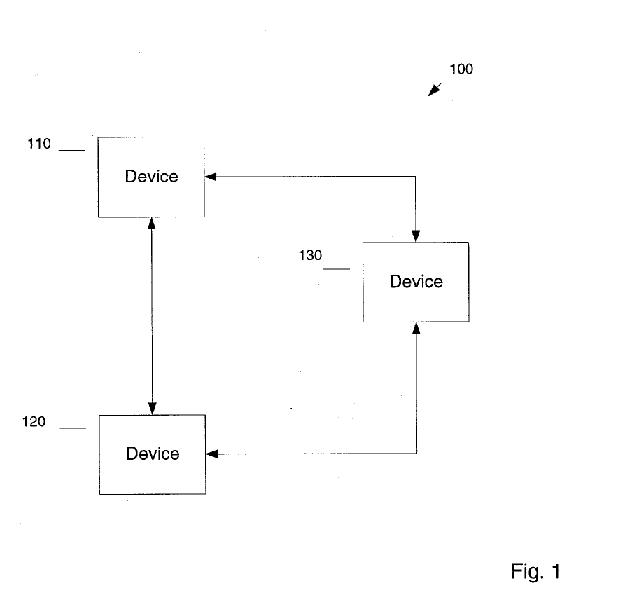

FIG. 1 illustrates a block diagram of a wireless personal area network according to one embodiment. In FIG. 1, device 110, device 120, and device 130 comprise the wireless personal area network 100. Each of the devices 110, 120, and 130 within the WPAN 100 intercommunicate via wireless communication (e.g., without device cables, wire, or adapters, etc) to transmit voice, data, video, and images. The wireless communication technologies may include digital radio based data transfer (e.g., Bluetooth, 802.11a, 802.11b, 802.11g, HomeRF, etc) and infrared light signals (e.g., InfraRed Data Association (IrDA) standard), among other wireless protocols. In this way, devices 110, 120 and 130 may communicate with each other over different wireless protocols. For instance, device 110 and device 120 may communicate over the Bluetooth communications protocol; device 120 and device 130 may communicate over the 802.11b communications protocol, while device 130 and device 110 communicate over the infrared communications protocol.

Typically, for devices 110, 120, and 130 to communicate, they must be within a specific physical distance of each other, although they are not necessarily required to be within a line of sight. This way, the communications link between mobile devices on a WPAN may engage or disengage while the device is mobile. However, it should be understood that a device might also engage multiple WPANs simultaneously.

By way of example, device 110 may be a PDA device, device 120 may be a portable computer (e.g., laptop computer), and device 130 may be a desktop computer, each communicating with a well-known compatible wireless communication protocol. It should be understood that the invention is not limited to the described devices. In alternative embodiments, devices on the WPAN 100 may include phones, pagers, digital cameras, scanners, printers, or other electronic devices, etc. In one embodiment, each device includes components of a scalable migration system that enables each device to scale its resource use, as will be further described below.

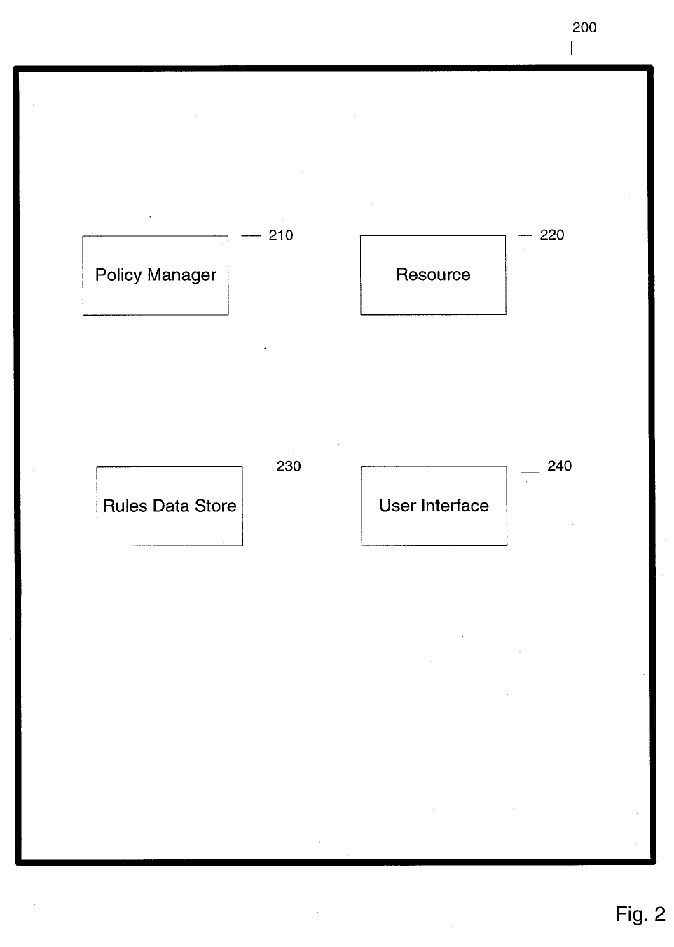

FIG. 2 illustrates a block diagram of a scalable migration system according to an embodiment. The scalable migration system 200 includes a policy manager 210, a resource 220, a rules data store 230, and a user interface 240. One or more of the components of the scalable migration system 200 are resident on each of the devices in the wireless personal area network 100.

The resources 220 describe those resources capable of transitioning or migrating from one device to another. Two categories of such resources are hardware resources and service resources. Examples of hardware resources include a keyboard, a display, and a speaker, among other examples. Examples of service resources include software applications, such as, a notification service and a speech processing service, among other examples. In some cases, the scalable migration is made from a local device executing a local resource to a remote device having access to a remote resource with greater resource capability (e.g., processing capability, bandwidth, data storage, multimedia functionality, etc.).

The rules data store 230 stores one or more policy rules. The rules data store 230 may be resident in a conventional memory or a persistent storage device (e.g., within a database). A policy rule describes a condition or conditions upon which an action may be performed upon the detection of a happening of an event on the WPAN 100. For example, the action to be performed might be based on the environmental condition of one or more devices and resources in the WPAN 100 at any one time, as will be further described below.

In one embodiment, the policy rule provides migration logic information of whether a local device should seamlessly migrate from the use of a local resource on the local device to the use of a remote resource on a remote device on the WPAN 100. The policy rule may also provide information of whether a local device should permit use of a local resource 220 if requested by a remote device on the WPAN 100.

For instance, a policy rule may be configured to define the migration logic for the audio output for a PDA device (e.g., the migration information for directing the audio output of music recordings on a PDA device). The policy rule may indicate that when the PDA device is in range of a wireless headset device), the audio output of an executing music recording is to be seamlessly migrated from the audio output of the PDA speaker device to the audio output of the wireless headset device. The seamless migration is to be transparent to the user of the PDA device (e.g., meaning the music will not be interrupted).

In one embodiment, the migration of the resource is performed by first transferring the file that is being processed to the remote device to be processed. For example, the audio data playing on a local device is first transferred to a remote device before the processing of the audio on the local device is ended. Here, the local device may have a data store, such as, a cache memory, from which the audio is played from until the transferred audio begins to play on the remote device. Therefore, both the local and remote device may perform the playing of the audio simultaneously for a short or long period of time, depending on the user preferences.

In one embodiment, a timing mechanism may be used to allow for the local device to end playing at substantially the same time the remote device begins to perform the playing of the audio. Either policy managers or audio software modules, on the local and remote devices, may coordinate the transfer of information between the local and remote device that determines the point the local device will end playing and the remote device will start playing. In this way there is no discernible pause during the migration.

Depending on factors such as, the amount of space on the remote device, various amounts of the file may be transferred to the remote device to be processed. For example, instead of transferring the entire audio file, only the portion that is to be played is transferred, or streaming audio is transferred so that the audio is played immediately with substantially no storage required (e.g., in the case of a wireless headset).

As stated above, the policy rule may also provide information of whether a local device should permit access to a local resource 220 when requested by a remote device on the WPAN 100. For example, a wireless speaker device may have a policy rule configured with information of whether to permit a remote PDA device playing a music recording to seamlessly use the audio output of a local wireless speaker device.

It should be appreciated that in this way, a policy rule may prioritize or provide a hierarchy to migrating the use of a resource, thereby instructing a migration to a remote device on the WPAN 100 with superior or better resources.

The policy rules stored in rules data store 230 may be accessed and configured by the owner/administrator of the device though a user interface 240 (e.g., a web-browser) on the device or from a remote device. In one embodiment, one or more policy rules may exist for each local resource available on the local device. If the device has multiple users, multiple user access control may be enabled to provide read and/or write access to each policy rule based on the resource, the user access rights, classes of resources (e.g., an “input resource” class may include keyboard and mouse), and/or a policy rule may apply to the device as a whole. For example, different users will have different permissions to view and update the policy rules. Therefore, some of the policy rule updates could apply to particular user(s), to class(es) of user, or to all users.

The policy manager 210 applies the information from the appropriate policy rule upon the happening of an event (e.g., connection of a device to the WPAN 100) corresponding to the rule. In one embodiment, the policy manager 210 accesses the appropriate policy rule in the rules data store 230 to either obtain information on whether to migrate to a specific remote resource or to permit remote use to a local resource. That is, the policy manager 210 controls what resources it makes available for remote devices to use and what resources of remote devices the local device uses.

In one embodiment, an event (also denoted as a trigger event) occurs when the policy manager 210 is notified that a device has connected to or disconnected from the wireless personal area network 100. For example, an event occurs when a device enters the WPAN and advertises itself to the other devices on the WPAN. In processing the event, the policy manager on the other devices may determine to perform operations such as “record event” for its local software module(s) to poll, or invoke a local software module that has registered to be called when that type of event (e.g., black and white printer resource, or handheld device availability) occurs. In addition, a local device may also query the WPAN for the resources it may want to migrate its use to upon entering a WPAN.

The policy manager may also operate based on queries by software modules on the device. For instance, after a device enters the WPAN 100 and before it advertises itself, the policy manager 210 on that device may be employed by software on the device to determine which resources should be advertised as available to be shared with other devices based on one or more policy rules in the rules data store 230. The decision may be based on information, such as, if running on AC power, advertise resources; if communicating over a low speed wireless link, do not advertise resources and resource capabilities that require high bandwidth, for example. This operation may or may not be triggered by a specific external event. (For instance, a software component on the device may decide to expose a resource as available for use by other devices).

An event may also occur when the policy manager 210 is notified of a state change in WPAN 100. A state change may occur to the WPAN 100, a device 110, 120, 130, or a resource 220. For example, a state change event may occur when a device transitions from running off a battery to running off AC (Alternating Current) power. Also, a state change may occur when a resource transitions from being in use to being idle, for example.

These examples show that when a remote device attempts to use a resource, the policy manager (on the device supplying the resource) may be called upon again to aid in determining the type of access the remote device is allowed to the resource, if any. For instance, the resource may be available for use only to specific user or groups of users, users with specific roles, or the resource may be available for use only by one user device at a time. In addition, prioritization may take into account other conditions such as environmental considerations (for instance, in a very noisy environment, it may make more sense to use a headset than speakers for audio out).

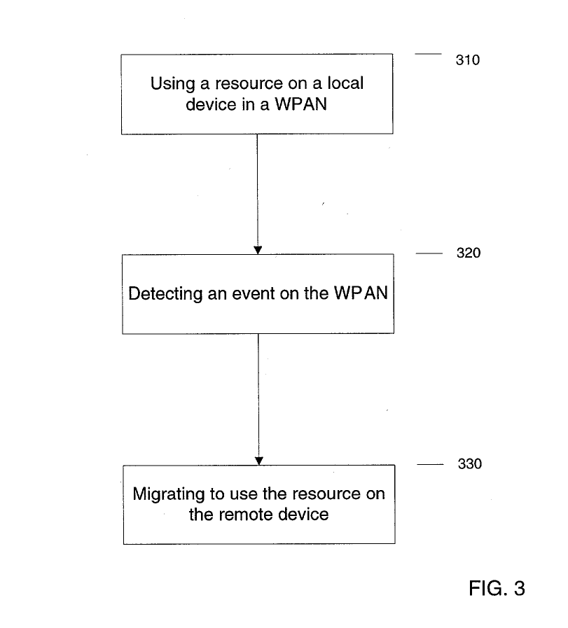

In one embodiment, the policy manager 210, upon receiving an event notification, accesses the rules data store 230 to determine whether to migrate from using a local resource to using a resource on a remote device on the WPAN 100. FIG. 3 illustrates a processing flow diagram for accessing a remote resource according to one embodiment. At block 310, a local resource 220 is executing on a local device 110 in the WPAN 100. For example, the local resource 220 may perform speech processing to convert speech-to-text on device 110. In this example, the local device 110 includes all of the components of the scalable migration system 200.

At block 320, the policy manager 220 of the local device 110 is notified of an event on the WPAN 100 via a notification. There are existing standards, such as Universal Plug and Play (UPnP) protocols that feature an event mechanism that notifies software modules when certain device-related events occur. For example, the devices 110, 120, and 130 may be registered with UPnP protocols that will enable the notification of devices 110, 120, and 130 when a device connects to or disconnects from the WPAN 100. The notification includes information about the device connecting/disconnecting from the WPAN 100. If additional information is needed, a query for more detailed information about a specific device and the resources provided by the device may be performed.

It is understood, that the invention is not limited to obtaining information about a device using the UPnP protocol. A local device may also make a request directly to a remote device (e.g., via an application program interface (API) call) or accesses other information sources (e.g., OEM website, a directory on the Internet, etc.,) to obtain the required information about the device.

Information provided by the trigger event notification or other sources may include: whether a device is running off of battery or AC power; who a device is “owned” by; how busy a resource is; how much functionality (e.g., bandwidth, processing power, etc.) a resource provides; the historical resource use information for the current user; and the number of current and supported users of the resource, among other examples.

In one embodiment, upon receiving the necessary information, the policy manager 210 will access the appropriate one or more policy rule(s) for information. In another embodiment, the executing application will access the appropriate policy rule for information after the policy manager 210 passes the notification information to the executing application on the device 110 or to a data store where the executing application may later access the information. In this way, either the policy manager 210 or an executing application decides whether to migrate or determining the timing of the migration, based on the event notification information and associated policy rule(s).

In one embodiment, the policy manager 220 of the device 110 accesses the rules data store 230 to determine whether to transition use of the resource of device 110 to use of the resource on device 120, based on the event notification information provided and the policy rules. Continuing the example, when the device 110 receives an event notification of the remote device 120 recently connecting on the WPAN 100, the policy manager 220 accesses the rules data store 230 for the associated policy rule based on the event notification information. If additional information is required the policy manager 210 may request the additional information from the device 120 (e.g., using the UPnP protocol).

At block 330, upon determining it is necessary or desired to migrate use of a resource and upon receiving the necessary information, a communications connection is made to the device 120 and the resource use is transitioned. Continuing the example, from the information obtained from the policy rule the profile manager 210 or executing application may determine the device 120 has better speech processing capability; therefore the policy manager 220 makes a communication connection to the device 120 to migrate the performance of the speech-to-text speech processing to the corresponding remote resource on the device 120.

It should also be understood that another scalable migration of resources might occur if a new resource with superior resource characteristics subsequently connects to the WPAN 100. To continue the example, if the policy manager 220 detects (e.g., via an event notification) the recent connection of device 130 to the WPAN 100 and after accessing the corresponding policy rule information determines that device 130 has superior speech-to-text speech processing, the policy manager 210 of the device 110 makes a new communications connection to device 130 to migrate the processing to the corresponding remote resource in device 130 of the speech-to-text speech processing, and terminates the communications connection with the device 120.

As stated above, a local device may also permit local resource 220 to be utilized by a remote device. Here, a local device may announce its resources to the other devices on the WPAN 100 or reply to a response for information about a specific local resource, a specific set of local resources, or all the local resources. In one embodiment, the policy manager of the local device may be configured to determine which of the local resources it should return information about. For example, the local device may be in a state in which it chooses not to return UPnP information about itself in response to queries and may choose not to announce itself. In other cases, the local device may be configured (through policy rules) to always announce everything about itself, and to respond to all queries. Or, the device may announce some of its attributes, and respond only to certain queries about itself and its resources depending on the request (e.g., which remote device is making the request, which user is making the request, etc.).

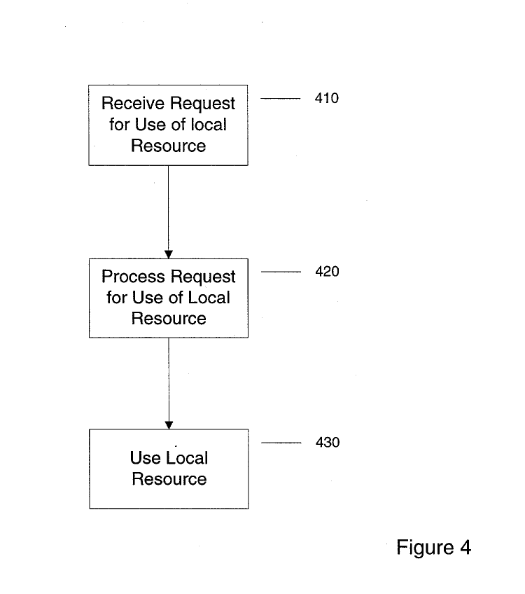

FIG. 4 illustrates a processing flow diagram of the utilization of a local resource on a local device according to one embodiment. At block 410, the policy manager 210 of a local device receives a request from a remote device to utilize a local resource.

At block 420, the device processes the resource request. Here, the policy manager 210 may determine whether to permit the remote device to use the local resource based on the resource request information and associated policy rule(s), in addition to other policy rule(s) associated with one or more resources, one or more devices, and the WPAN 100. For example, providing access may be determined based on the requestor device or the requestor user, the resource requested, the resources available on the local device whether the local device is running on battery power, and the amount of bandwidth available on the WPAN 100, among other examples.

At block 430, upon request processing, a connection is accepted with the remote device on the wide area personal network 100 and the local resource is executed for the requesting device.

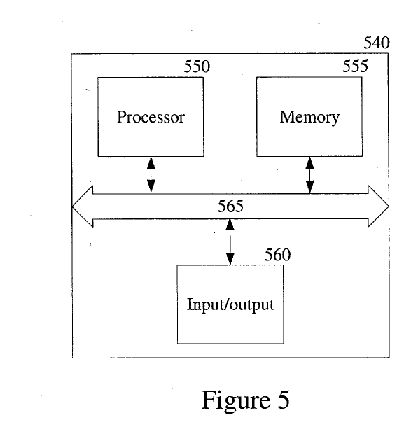

One embodiment of a computer system suitable for a wireless personal area network scalable migration system is illustrated in FIG. 5. The computer system 540 includes a processor 550, memory 555 and input/output capability 560 coupled to a system bus 565. The memory 555 is configured to store instructions which, when executed by the processor 550, perform the methods described herein. The memory 555 may also store policy rules. Input/output 560 provides for communications to/from other computer systems, the delivery and display of multimedia content (including audio, visual, text data, etc.), and allows for the modification of the policy rules. Input/output 560 also encompasses various types of machine-readable media, including any type of storage device (e.g., rules data store 230) that is accessible by the processor 550.

The description of FIG. 5 is intended to provide an overview of computer hardware and other operating components suitable for implementing the invention, but is not intended to limit the applicable environments. It will be appreciated that the computer system 540 is one example of many possible computer systems that have different architectures. A typical computer system will usually include at least a processor, memory, and a bus coupling the memory to the processor. One of ordinary skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

It will be appreciated that more or fewer processes may be incorporated into the method illustrated in FIGS. 3 and 4 without departing from the scope of the invention and that no particular order is implied by the arrangement of blocks shown and described herein. It further will be appreciated that the method described in conjunction with FIGS. 3 and 4 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The method may be provided as a computer program product that may include a machine-readable medium having stored thereon instructions that may be used to program a computer (or other electronic devices) to perform the method. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and a carrier wave that encodes a data signal. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

It should be appreciated that a user may configure a mobile device via a policy rule, to migrate to the most optimal or superior remote resource on the WPAN. The seamless scalable migration of resources based on a set of policy rules is advantageous over the manual selection of resources by a user that might not know that a superior resource has entered the WPAN. In this way the invention takes advantage of the richness of multiple WPAN environments, such as when a mobile device moves from the home based WPAN to an automobile based WPAN to the corporate based WPAN. Therefore, enabling the wireless mobile device to interact with other devices in useful ways.

According to another embodiment of the invention, upon determining that there are multiple candidate resources to migrate to, the user interface may be presented to the user to enable the user to choose a preferred resource from the multiple candidates. In addition, before any resource is allowed to have its use migrated, the device may present a user interface to the user, before effecting the change, to allow the user to override the migration from one resource to another (e.g., by asking the user to confirm or deny the migration).

In addition, embodiments of the invention allows for the use of a resource sharing framework and a policy manager to affect the migration by allowing a platform vendor, an application vendor, or the user to configure a device for resource migration, and to affect the migration based on the configuration when specific events occur.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A system comprising:
a network;
a first device including a first resource; and
a second device including a policy manager and a second resource, the second resource being provided on the second device, the policy manager to migrate use of the second resource to use of the first resource on the first device upon detecting an event on the network based on a policy rule.

2. The system of claim 1 wherein the second device determines whether to migrate the use of the second resource to use of the first resource of the first device.

3. The system of claim 1 wherein the policy manager determines whether to migrate use of the second resource to use of the first resource of the first device.

4. The system of claim 1 wherein the second device includes a rules data store, the rules data store to store policy rules, the policy rules to include information for determining when to migrate to the first device.

5. The system of claim 1 wherein the devices are wireless devices communicating via a wireless communications protocol.

6. The system of claim 1 wherein the migration of use of the second resource to use of the first resource on the first device further comprises starting use of the first resource on the first device at substantially the same time use of the second resource on the second device is ended.

7. The system of claim 1 further comprising:
a third device, upon detecting and joining the WPAN, the policy manager on the second device to determine whether to use the processing resource on the third device based on the policy rule, and another policy manager on the third device to determine whether to permit the use of the processing resource on the third device based on another policy rule on the third device.

8. The system of claim 1 wherein the network comprises a wireless personal area network.

9. A method comprising:
using a resource on a local device on a wireless personal area network;
detecting an event on the wireless personal area network; and
migrating the use of the resource to a remote device based on a policy rule associated with the event.

10. The method of claim 9 wherein the detecting further comprises:
receiving a notification from the remote device, the notification including device information wherein the migrating being further based on the device information.

11. The method of claim 9 wherein the policy rule includes information of whether to migrate.

12. The method of claim 9 wherein migrating the use of the resource to a remote device further comprising ending the use of the resource on the local device at substantially the same time.

13. An apparatus comprising:
a resource executable on the apparatus; and
a policy manager to migrate use of the resource to a remote apparatus upon detection of an event associated with a policy rule.

14. The apparatus of claim 13 wherein the event further comprises receiving a notification of the remote apparatus connecting from a wireless network, the notification includes information about the remote apparatus being further used with the policy rule to determine whether to migrate the resource use.

15. The apparatus of claim 13 wherein the notification being via a Universal Plug and Play protocol communication.

16. The apparatus of claim 13 wherein the event further comprises receiving a notification of the remote apparatus connecting to a wireless network, the notification includes information about the remote apparatus being further used with the policy rule to determine whether to migrate the resource use.

17. The apparatus of claim 13 wherein the policy manager to communicate with the executable resource determines whether to perform the migration.

18. The apparatus of claim 13 wherein the policy manager communicates with the remote device via a wireless communication protocol.

19. The apparatus of claim 13 further comprising:
a rules datastore to store the policy rule.

20. The apparatus of claim 13 wherein the migration of the use of the resource to the remote apparatus further comprising ending the processing of the resource executable.

21. The apparatus of claim 13 further comprising:
a user interface to update the policy rule.

22. The apparatus of claim 13 wherein the policy manager detects a third device and determines whether to use the resource on the third device.

23. A machine-readable medium having executable instructions to cause a machine to perform a method comprising:
using a resource on a local device on a wireless personal area network;
detecting an event on the wireless personal area network; and
migrating the processing of the resource to a remote device based on a policy rule associated with the event.

24. The machine-readable medium of claim 23 wherein the detecting further comprises:
receiving a notification from the remote device, the notification including device information wherein the migrating being further based on the device information.

25. The machine-readable medium of claim 23 wherein the policy rule includes information of whether to migrate.

26. The machine-readable medium of claim 23 wherein the migrating the use of the resource to a remote device further comprising ending the use of the resource on the local device at substantially the same time.
